(19) United States
(12) Patent Application Publication
(10) Pub. No.: US 2014/0033858 A1
(43) Pub. Date: Feb. 6, 2014

(54) ROLLER STRUCTURE FOR HIGH PRESSURE PUMP

(71) Applicant: HYUNDAI MOTOR COMPANY, Seoul (KR)

(72) Inventor: Yongsoon Park, Seongnam-si (KR)

(73) Assignee: Hyundai Motor Company, Seoul (KR)

(21) Appl. No.: 13/730,214

(22) Filed: Dec. 28, 2012

(30) Foreign Application Priority Data
Aug. 6, 2012 (KR) 10-2012-0085687

(51) Int. Cl. F16H 53/06

(52) U.S. Cl. CPC F16H 53/06
USPC 74/569

(57) ABSTRACT

A roller structure for a high pressure pump, the roller structure being applied to a tappet configured to convert a rotational movement to a rectilinear movement of a cam and transfer the converted rectilinear movement to a piston in the high pressure pump of an internal combustion engine, may include a roller main body installed inside the tappet and including grooves formed at both distal side ends thereof, respectively; and rolling members inserted in the grooves of both side surfaces of the roller main body in a longitudinal direction thereof, respectively.

### CROSS-REFERENCE TO RELATED APPLICATION

The present application claims priority to Korean Patent Application No. 10-2012-0085687 filed on Aug. 6, 2012, the entire contents of which is incorporated herein for all purposes by this reference.

### BACKGROUND OF THE INVENTION

1. Field of the Invention

The present invention relates to a roller structure for a high pressure pump, and more particularly, to a roller structure for a high pressure pump which is easily applied to a high pressure pump, such as a fuel pump of an internal combustion engine, thereby improving operability and processibility.

2. Description of Related Art

FIG. 1 is a cross-sectional view illustrating a high pressure fuel pump to which a roller in the related art is applied, and FIG. 2 is a diagram illustrating a roller applied to a high pressure fuel pump in the related art.

As illustrated in FIG. 1, a high pressure fuel pump applied to an internal combustion engine of a vehicle generally includes a piston 10 for pressurizing a fuel, a cam 2 disposed under the piston 10, a tappet 30 disposed between the cam 2 and the piston 10 to convert a rotational movement of the cam 2 to a rectilinear movement and transfer the converted rectilinear movement to the piston 10, a supporting member 40 disposed inside the tappet, a roller 50 installed inside the tappet 30 and the supporting member 40 to be in rolling contact with the cam 2, and a return spring 20 for providing restoration force to the piston 10.

As illustrated in FIG. 2, in a case of the aforementioned roller 50 applied to the high pressure fuel pump in the related art, both side end surfaces are formed in curved surface portions 51, so that abrasion between the roller 50 and the adjacent supporting member 40 or the tappet 30 is prevented.

Further, as illustrated in FIG. 2, coated parts 52 made of a wear resistant material are formed at center portions of the curved surface portions 51 of the roller 50, so that damage of the curved surface portions 51 is prevented when the roller is in contact with an adjacent component and life of the roller is extended.

However, in the aforementioned roller 50 in the related art, since the coated part 52 needs to be formed at only the center portion of the curved surface portion 51 for smooth rotation, a coating process itself is difficult and it is difficult to uniformly coat the roller with a uniform shape, such that it is disadvantageous to apply the coating.

Further, even though the aforementioned roller 50 in the related art is coated, in a case where the curved surface portion 51 is worn due to long-term use, it is necessary to exchange the roller 50 itself, such that there is a problem in that a period for replacement of the roller 50 is shortened and thus a cost increases.

In addition, it is necessary to process both of each of the side end surfaces of the roller 50 in the curved surface portion 51, for the smooth rotational movement, so that there is a problem of disadvantageous processibility.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY

Various aspects of the present invention are directed to providing a roller structure for a high pressure pump which may extend a period of replacement of a roller and has excellent processibility and achieves easy coating application. In order to solve the aforementioned problem, an exemplary embodiment of the present invention provides a roller structure for a high pressure pump.

In several exemplary embodiments, a roller structure for a high pressure pump, the roller structure being applied to a tappet configured to convert a rotational movement to a rectilinear movement of a cam and transfer the converted rectilinear movement to a piston in the high pressure pump of an internal combustion engine, may include a roller main body installed inside the tappet and including grooves formed at both distal side ends thereof, respectively, and rolling members inserted in the grooves of both side surfaces of the roller main body in a longitudinal direction thereof, respectively.

Each of the rolling members is shaped of a sphere.

A portion of a rolling member facing a direction of the tappet is formed as a curved surface portion, and a portion of the rolling member facing an opposite direction of the tappet is formed as an insertion part inserted in a corresponding groove.

The grooves are formed at a rotation axis of the both distal side ends of the roller main body, respectively.

The rolling members are in rolling contact with an inner circumferential surface of the tappet or an inner circumferential surface of a supporting member disposed inside the tappet, wherein the both distal side surfaces of the roller main body are spaced apart by a predetermined interval from an inner circumferential surface of the tappet or the supporting member which is in rolling contact with the rolling member.

A coated part is formed at an outer circumferential surface of the rolling member.

The coated part is formed of any one of a ceramic material, a carbon compound, titanium nitride, tungsten carbide carbon, or a wear resistant alloy.

Each of corner portions at the both distal side surfaces of the roller main body is curved in a direction of a circumference.

An outer corner portion and an inner corner portion of each of the grooves are curved in a direction of a circumference thereof.

According to the roller structure for the high pressure pump of the present invention, since the roller main body and the rolling member are separately configured, when the respective members are damaged or worn, it is possible to separately replace the respective members, thereby achieving an effect in that replacement expenses are decreased compared to the related art.

Further, in the roller structure for the high pressure pump of the present invention, it is sufficient to perform coating on only the entire rolling member, thereby achieving an effect in that a coating operation itself is easy and it is possible to uniformly form the coated part.

In addition, in the roller structure for the high pressure pump of the present invention, the rolling member may be formed in a shape of a ball, and in this case, it is not necessary to separately perform an operation of processing the side surface of the roller into the curved surface portion, thereby achieving an effect in that processibility and applicability are improved.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a cross-sectional view of a high pressure fuel pump in the related art.

FIG. 2 is a view illustrating a roller of the high pressure fuel pump of FIG. 1.

FIG. 3 is a cross-sectional view of a roller structure for a high pressure pump according to an exemplary embodiment of the present invention.

FIG. 4 is a cross-sectional side view of a roller structure for a high pressure pump according to an exemplary embodiment of the present invention.

FIG. 5 is a cross-sectional view of a roller structure for a high pressure pump according to another exemplary embodiment of the present invention.

FIG. 6 is a cross-sectional view of a roller structure for a high pressure pump according to another exemplary embodiment of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that the present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

Hereinafter, exemplary embodiments of the present invention will be described in detail with reference to the accompanying drawings.

For the convenience of description, an upper side based on the accompanying drawing may be defined as an “upper portion”, and an “upper side” in term of a direction, and similarly, a lower side, a left side, and a right side based on the accompanying drawing may be defined as a “lower portion and lower side”, a “left side”, and a “right side”, respectively, in terms of a direction.

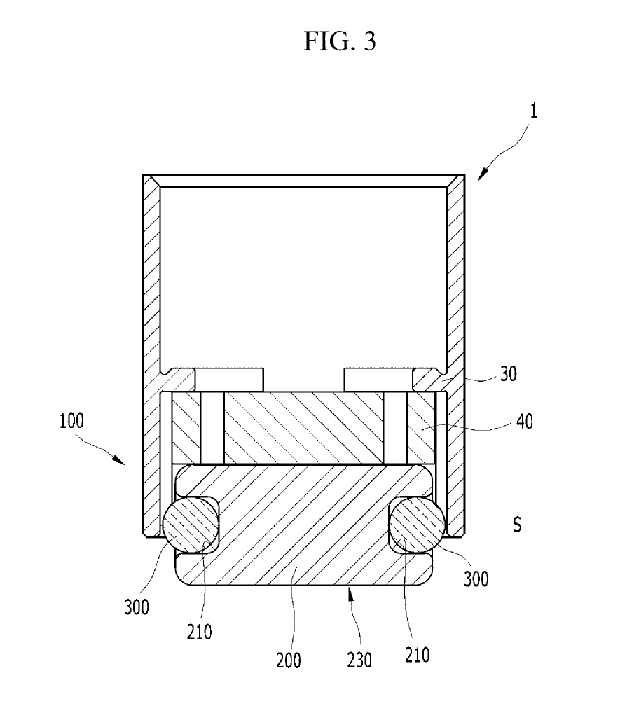

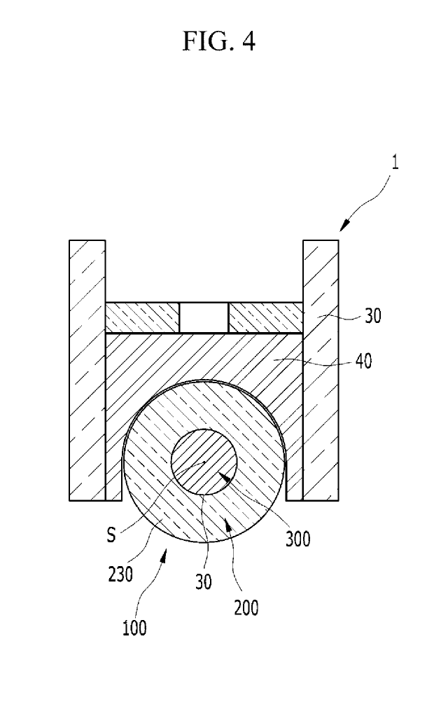

FIG. 3 is a cross-sectional view of a roller structure 100 for a high pressure pump according to an exemplary embodiment of the present invention, and FIG. 4 is a longitudinal sectional view of the roller structure 100 for a high pressure pump according to an exemplary embodiment of the present invention.

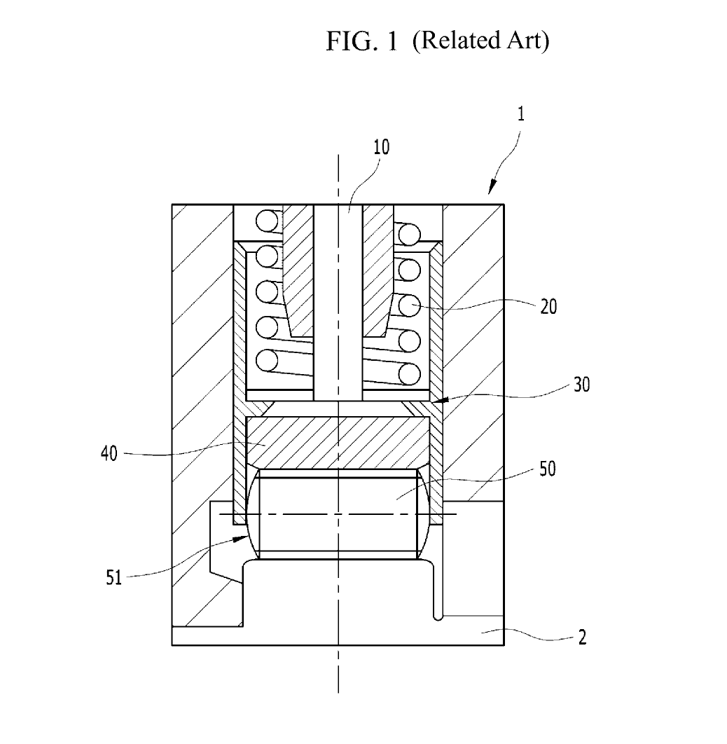

The remaining structures of a high pressure pump 1, except for the roller structure 100 is substantially the same as the configuration of the high pressure fuel pump according to the related art. Accordingly, a structure of the high pressure pump includes, as illustrated in FIG. 1, a piston 10 for pressurizing a fuel, a cam 2 disposed under the piston 10, a tappet 30 disposed between the cam 2 and the piston 10 to convert a rotational movement of the cam 2 to a rectilinear movement and transfer the converted rectilinear movement to the piston 10, a supporting member 40 disposed inside the tappet 30, a roller 50 installed inside the tappet 30 and the supporting member 40 to be in rolling contact with the cam 2, and a return spring 20 for providing restoration force to the piston 10.

As illustrated in FIG. 3, the roller structure 100 for the high pressure pump according to the exemplary embodiment of the present invention is applied to the tappet 30 for converting the rotational movement of the cam to the rectilinear movement and transferring the converted rectilinear movement to the piston in the high pressure pump 1, such as the high pressure fuel pump illustrated in FIG. 1, of the internal combustion engine, and may include a roller main body 200 installed inside the tappet 30 and provided with grooves 210 at both side ends, and rolling members 300 inserted in the grooves 210 at both side surfaces of the roller main body 200, respectively.

The roller main body 200 is installed inside the tappet 30, and, as illustrated in FIG. 1, is a part rotating while being in contact with the cam 2 positioned under the high pressure pump 1.

The supporting member 40 may be installed inside the tappet 30 and on upper portion of the roller main body 200. Accordingly, when the supporting member 40 is installed inside the tappet 30 as illustrated in FIGS. 3 and 4, the roller main body 200 is rotatably mounted inside the supporting member 40.

In the meantime, the supporting member 40 may be omitted, and when the supporting member 40 is omitted, an inner circumferential surface of the tappet 30 is in direct contact with a rotation surface 230 of the roller main body 200, so that the roller may rotate with respect to a center S of rotation.

The grooves 210 are formed at both side end surfaces of the roller main body 200, respectively.

The grooves 210 may be formed by removing round cross-sectional center portions in a left side and a right side of the roller main body 200 in a predetermined depth as illustrated in FIGS. 3 and 4.

The rolling members 300 are inserted inside the grooves 210, respectively, to decrease friction at side surfaces.

When the supporting member 40 is installed inside the tappet 30, the rolling member 300 may be in rolling contact with an inner circumferential surface of the supporting member 40 as illustrated in FIGS. 3 and 4, and when the supporting member 40 is omitted, the rolling member 300 may be in direct rolling contact with the inner circumferential surface of the tappet 30.

Accordingly, both side surfaces of the roller main body 200 are spaced apart by a predetermined interval from the inner circumferential surface of the tappet 30 which is in contact with the rolling member 300 by the rolling member as illustrated in FIG. 3.

In one or more several exemplary embodiments, the rolling member 300 may be formed of a sphere-shaped ball as illustrated in FIGS. 3 and 4. When the rolling member 300 is formed of the ball, the ball is inserted in each of the grooves 210 formed at both side surfaces of the roller main body 200 and is in point contact with an inner circumferential surface of the groove 210 and the inner circumferential surface of the tappet 30 or the supporting member 40.

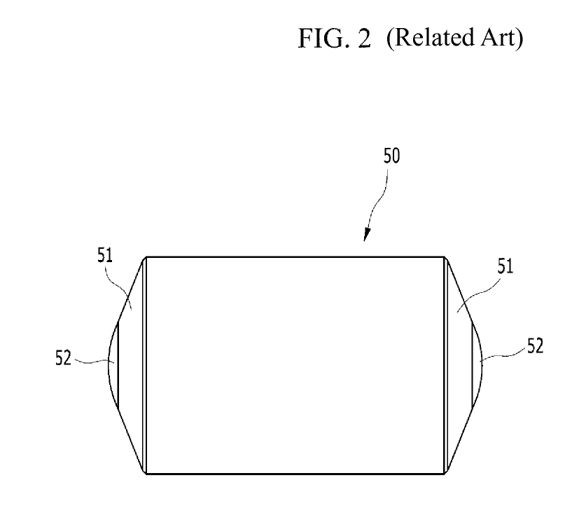

A difference between the present invention and the related art is that in a case of the roller in the related art illustrated in FIGS. 1 and 2, the side surfaces are simply processed to the curved surface portions 51 so that only specific points 52 are continuously in contact with the inner circumferential surfaces of the tappet 30, but when the rolling member 300 shaped like a ball is applied like the present invention, the rolling member 300 is in point contact with the inner circumferential surface of the tappet 30 or the supporting member 40 and simultaneously, the ball rotates while being in rolling contact with the inner circumferential surface of the tappet 30 or the supporting member 40 and the groove 210 in an operation of the roller, thereby reducing friction.

As illustrated in FIG. 3, according to the roller structure 100 of the present invention to which the ball is applied, all surfaces of the ball 300 may be evenly rubbed by the rotation and a size of friction force applied to the ball 30 is remarkably decreased. Accordingly, abrasion of the contact surface is decreased and life of the roller may be extended.

Further, in a case of the roller 50 in the related art, it is necessary to replace the entire roller 50 when the contact surface 52 of the curved surface portion 51 is damaged, but according to an exemplary embodiment of the present invention, when an outer circumferential surface of the ball 300 is worn or damaged due to the long-term use, it is possible to separately replace only the ball 300, except for the roller main body 200, thereby reducing an expense for replacement.

In the meantime, in one or multiple exemplary embodiments, the rolling member 300 may be manufactured in another shape, not the ball shape.

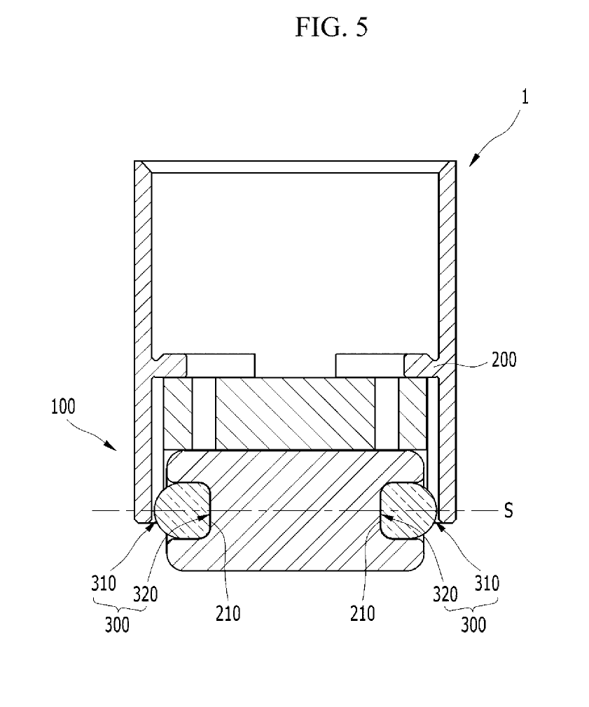

As illustrated in FIG. 5, a portion of the rolling member 300 facing a direction of the tappet 30 is formed as the curved surface portion 310 of a spherical surface or a round surface, and a portion of the rolling member 300 facing an opposite direction of the tappet 30 is formed as an insertion portion 320 shaped like a cylinder inserted in the groove 210.

The insertion portion 320 may have any shape other than the cylindrical shape if the insertion portion 320 may be inserted in the groove 210. Accordingly, the insertion portion may be formed in a shape of a spherical surface or a round surface.

The rolling member 300 illustrated in FIG. 5 may rotate only in a direction of a rotation axis of the roller, so that the friction may increase compared to the rolling member shaped like a ball which is rotatable in every direction. However, since the rolling member 300 and the roller main body 200 are separately configured, a rotation speed and a rotation direction of the rolling member 300 may be different from those of the roller main body 200, thereby achieving an effect in that the friction of the rolling member 300 against the inner circumferential surface of the tappet 30 or the supporting member 40 is decreased compared to the related art. Further, when the rolling member 300 is worn, it is possible to replace the rolling member 300 separately from the roller main body 200, so that the rolling member 300 is advantageous in terms of expenses compared to the related art.

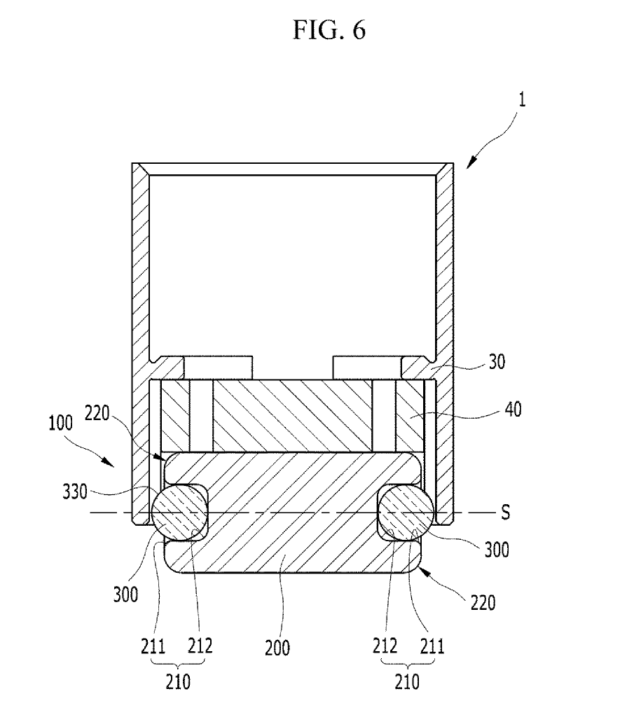

Coated parts 330 may be formed at the outer circumferential surfaces of the rolling members 300 as illustrated in FIG. 6.

The coated part 330 is formed of a wear resistant material to extend life of the rolling member 300.

In one or multiple exemplary embodiments, the coated part 330 may be formed of any one of a ceramic material, a carbon compound, titanium nitride, or a wear resistant alloy.

The wear resistant alloy may be a tin-based alloy partially containing Cu, Zn, In, Sb, or Ag, or an alloy including hard particles in a form of nitride or carbide.

When tungsten carbide carbon is coated on the rolling member 300, durability is improved and the friction coefficient is simultaneously decreased, so that a sliding property may also be improved.

The coated part 330 may include one or more layers. When the coated part 330 includes a plurality of layers, optimum wear resistance and sliding property may be secured by using the respective layers formed of the same material or having the same thickness or differentiating a material or a thickness of each layer.

Particularly, in an exemplary embodiment of the present invention, the rolling member 300 is configured as a separate component from the roller main body 200, so that a coating operation is advantageously easy compared to the related art. That is, as illustrated in FIG. 2, in the related art, since the curved surface portion 51 is integrally formed with the roller 50, only the portion of the contact surface 52 needs to be coated, so that a coating operation itself is difficult and uniform coating is not achieved. However, in an exemplary embodiment of the present invention, it is sufficient to perform the coating on only the entire rolling member 300, so that the coating operation itself is easy and the coated part 330 may be uniformly formed.

In the meantime, each of corner portions of both side surfaces of the roller main body 200 may be curved in a direction of a circumference, and an outer corner portion and an inner corner portion of each of the grooves 210 may also be curved in a direction of the circumference.

As illustrated in FIG. 6, the corner portions 220 of both side surfaces of the roller main body 200 in the direction of the circumference and the outer corner portion 211 and the inner corner portion 212 of each of the grooves 210 in the direction of the circumference are curved as the curved surfaces, so that the roller may be smoothly rotated and the corner portions of the roller may be prevented from being damaged due to friction.

For convenience in explanation and accurate definition in the appended claims, the terms “upper”, “lower”, “inner” and “outer” are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A roller structure for a high pressure pump, the roller structure being applied to a tappet configured to convert a rotational movement to a rectilinear movement of a cam and transfer the converted rectilinear movement to a piston in the high pressure pump of an internal combustion engine, the roller structure comprising:
a roller main body installed inside the tappet and including grooves formed at both distal side ends thereof, respectively; and
rolling members inserted in the grooves of both side surfaces of the roller main body in a longitudinal direction thereof, respectively.

2. The roller structure of claim 1, wherein each of the rolling members is shaped of a sphere.

3. The roller structure of claim 1, wherein a portion of a rolling member facing a direction of the tappet is formed as a curved surface portion, and a portion of the rolling member facing an opposite direction of the tappet is formed as an insertion part inserted in a corresponding groove.

4. The roller structure of claim 1, wherein the grooves are formed at a rotation axis of the both distal side ends of the roller main body, respectively.

5. The roller structure of claim 1,
wherein the rolling members are in rolling contact with an inner circumferential surface of the tappet or an inner circumferential surface of a supporting member disposed inside the tappet, and
wherein the both distal side surfaces of the roller main body are spaced apart by a predetermined interval from an inner circumferential surface of the tappet or the supporting member which is in rolling contact with the rolling member.

6. The roller structure of claim 1, wherein a coated part is formed at an outer circumferential surface of the rolling member.

7. The roller structure of claim 6, wherein the coated part is formed of any one of a ceramic material, a carbon compound, titanium nitride, tungsten carbide carbon, or a wear resistant alloy.

8. The roller structure of claim 1, wherein each of corner portions at the both distal side surfaces of the roller main body is curved in a direction of a circumference.

9. The roller structure of claim 1, wherein an outer corner portion and an inner corner portion of each of the grooves are curved in a direction of a circumference thereof.
